(19) United States
(12) Patent Application Publication
(10) Pub. No.: US 2018/0232685 A1
(43) Pub. Date: Aug. 16, 2018

(54) METHOD FOR LADING OPERATIONS AND DELIVERY OF CARGO

(71) Applicant: Uphill Holdings LLC, Humble, TX (US)

(72) Inventor: Quenton R. CHAMP, Humble, TX (US)

(21) Appl. No.: 15/434,109

(22) Filed: Feb. 16, 2017

(51) Int. Cl. G06Q 10/08; G06Q 30/04

(52) U.S. Cl. CPC G06Q 10/083; G06Q 30/04

(57) ABSTRACT

A computer-implemented method for delivering cargo is disclosed. The method includes: receiving a delivery request including a cargo description including an unconventional characteristic; calculating a quote for the delivery request based on the unconventional characteristic; selecting a driver and a linked truck to fulfill the delivery request; creating a job order based on the delivery request for the driver and the linked truck; and receiving a completion status for the job order.

### FIELD

The present teachings disclose a method and a system for lading operations and delivery of unusual and large cargo. In particular, the method and system may include web portals, mobile applications and back-end logic to order cargo transportation between different locations.

### BACKGROUND

In the prior art uses manual and telephone processes for connecting an end user to a Delivery Service (Shipping Company) and processing delivery of large unusually shaped cargo.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

For customers who want to transport cargo from one place to another, the present teachings provide an Internet-based and smartphone-enabled system that connects an end user to a delivery service (shipping company) and to facilitate dispatch and accounting for the delivery service. As each delivery service has own set of customers (customer database) and by default each customer works with own delivery service, the present teachings provide a Business-to-Business solution.

A computer-implemented method for delivering cargo is disclosed. The method including: receiving a delivery request including a cargo description including an unconventional characteristic; calculating a quote for the delivery request based on the unconventional characteristic; selecting a driver and a linked truck to fulfill the delivery request; creating a job order based on the delivery request for the driver and the linked truck; and receiving a completion status for the job order.

A computer-implemented method for delivering cargo is disclosed. The method including: receiving a delivery request including a cargo description, an origination site and a delivery site; calculating a quote for the delivery; setting, by a delivery service manager, an acceptance or rejection of the delivery request; notifying a customer of the acceptance or rejection of the delivery request and the quote; receiving an acceptance or rejection of the quote from the customer; selecting a driver and a linked truck to fulfill the delivery request; creating a job order based on the delivery request for the driver and the linked truck; and receiving a completion status for the job order.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates a block diagram of a system to provide delivery services for customers by shipping companies according to various embodiments.

FIG. 2 illustrates a schematic depicting actions that may taken by a user's role per the present teachings according to various embodiments.

FIG. 3 illustrates a block diagram depicting an order request workflow according to various embodiments.

FIG. 4 illustrates a state-transition diagram for a customer request/quote status and its valid transitions according to various embodiments.

FIG. 5 illustrates a state-transition diagram for an order/job request status and its valid transitions according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure.

The terminology used herein is for describing particular embodiments only and is not intended to be limiting of the present disclosure. As used herein, the singular forms “a,” “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to either identify individual elements or to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

The present teachings disclose various modules that may be accessed via a web portal and/or and an application portal. The present teachings further disclose a back-end that connects the modules. In some embodiments, the modules may be divided by a user role, for example, an administrator module, a Delivery Service (DS) module, a customer module, and a driver module. In some embodiments, a web portal may be provided for the administrator, DS and customer modules. In some embodiments, an application portal may be provided for the customer and driver modules. The application portal may interact with applications suited for use by a mobile device, such as, a tablet, a smart phone, a laptop or the like. In some embodiments, the system is oriented toward delivery services (or shipping companies), drivers and users who want to transport regular cargo from one place to another.

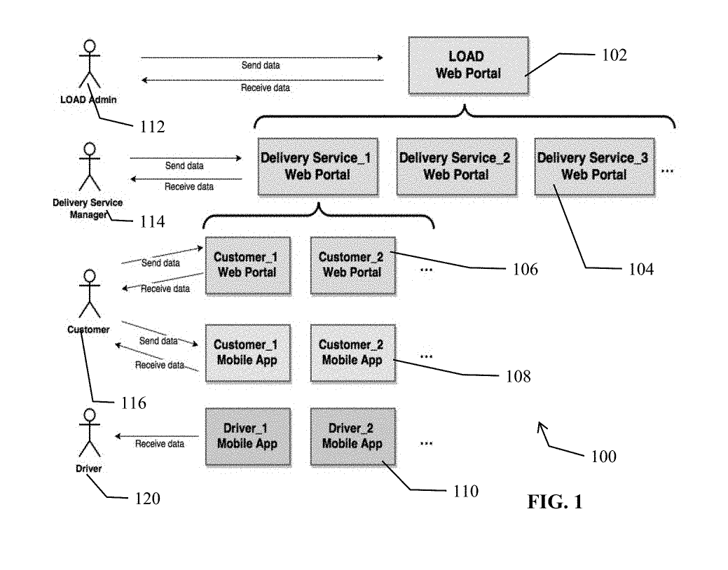

FIG. 1 illustrates a block diagram of a system to provide delivery services for customers by shipping companies according to various embodiments.

In exemplary embodiments, a system 100 provides delivery service for customers by shipping companies. The system 100 can include a web portal (load portal) 102 for use by a load admin 112, a delivery service web portal (DS portal) 104 for use by a DS manager 114, a customer web portal (customer portal) 106 and a customer mobile application (customer app) 108 for use by a customer 116, and a driver mobile application (driver app) 110 for use by a driver 120.

In exemplary embodiments, the admin 112 may access the web Portal 102 to register new delivery services, and manage and bill existing ones. The web portal 102 may include several Admins in the system 100.

In exemplary embodiments, a DS Manager 114 may access the DS web Portal 104. The DS manager 114 may be a delivery service employee who receives and processes delivery orders from Customers. In some embodiments, the DS manager 114 has the ability to add new users (DS Managers) to the DS web Portal 104 and manage existing ones. In exemplary embodiments, a system 100 may include several DS Managers 114 in the DS Portal 104. In exemplary embodiments, the system 100 may include one or more DS portals 104.

In exemplary embodiments, a customer 106 may access the system 100 via the Customer Portal 106 or via the customer Application 108. In some embodiments, the Customer 106 is a company that sends delivery requests to their Delivery Service. In exemplary embodiments, each Delivery Service may have about 10, about 100, about 1000 or more customers.

In exemplary embodiments, a driver 120 may access a driver application 110 for each delivery service that the driver 120 works with. In some embodiments, the system may provide for about 10, about 100, about 1000 or more drivers. In exemplary embodiments, the driver 120 may receive orders and deliver cargo. In some embodiments, each driver 120 has a truck and may access the load driver mobile app 100 through a smartphone.

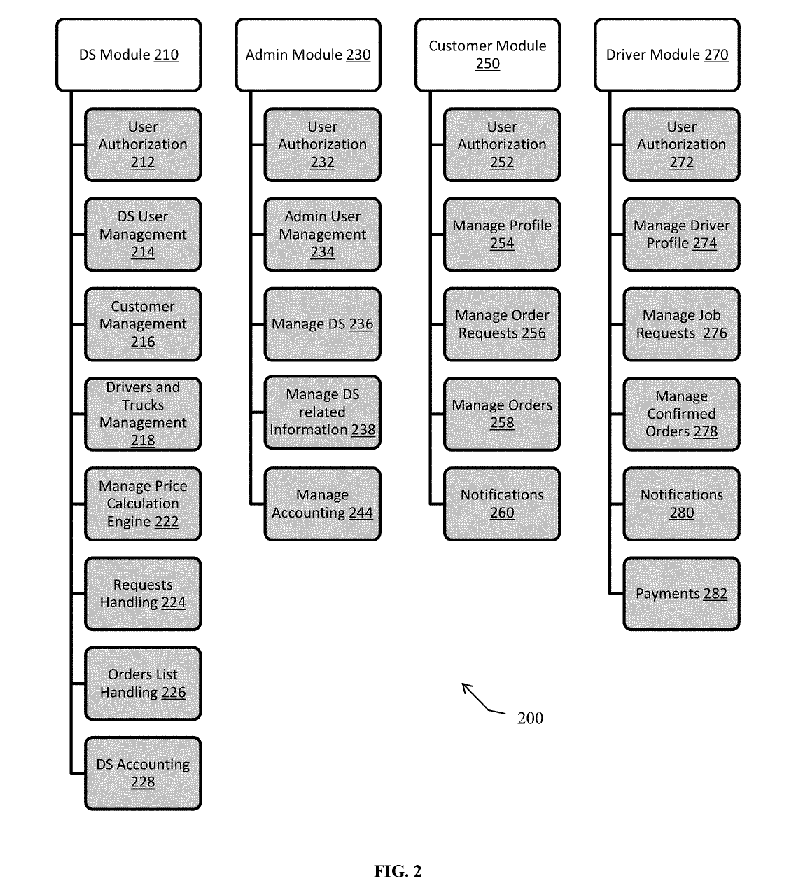

FIG. 2 illustrates a schematic depicting actions that may taken by a user's role per the present teachings according to various embodiments.

The present teachings disclose system actions 200 that may be provided by a DS module 210, an admin module 230, a customer module 250 and a driver module 270.

In some embodiments, the DS module 210 allow a DS user to take actions for User Authorization 212, DS user management 214, customer management 216, drivers and trucks management 218, manage price calculation engine 222, requests handling 224, orders list handling 226 and DS accounting 228. The user authorization 212 may include actions such as sign-in, and forgot password. The DS user management 214 may include actions such as create a new DS user, view/update DS user info, delete DS user, view DS user list and manage own profile information. The view DS customers 216 may include actions such as view customer list, view customer information. The view drivers and trucks 218 may include actions such as view driver list, and view driver and truck(s) information. The manage price calculation engine 222 may include actions such as set update default price per mile, set/update default charge for weight, set/update default charge for size, and set/update additional charge (driver fee, waiting time, additional equipment, round trip). The requests handling 224 may include actions such as view order requests, accept order request, reject order request, view drivers/trucks suggestions, assign driver to order request (send driver a job), receive job acceptance/rejection notification+comment, and receive order creation notification. The orders handling 226 may include actions such as view order list, view order information, cancel order, and change order status (invoiced, paid). The DS accounting 228 may include actions such as view orders related info for each customer, view driver commission from each order (%), view monthly subscription fee for each active driver, invoice list, and generate invoice (e.g., PDF) for chosen period (from-to) to charge customer.

In some embodiments, the admin module 230 allows an administrator to take actions for user authorization 232, admin user management 234, manage DS 236, manage DS related information 238 and manage accounting 244.

The user authorization 232 may include actions such as sign-in and forgot password. The admin user management 234 may include actions such as create a new admin user, view/update admin user info, delete admin user, view admin user list, and manage own profile info. The manage DS 236 may include actions such as register/create a new delivery service, view/update delivery service info, delete delivery service, and view delivery service list. The manage DS related information 238 may include actions such as, Create, Read, Update, Delete, List (CRUDL) Customers for selected DS, CRUDL Drivers and Trucks for selected DS, CRUDL users (DS Managers) for selected DS, and view Price management parameters for selected DS. The manage DS users 240 may include actions such as view driver list in DS, view driver and trucks information in DS, add a new driver and trucks in DS, update driver and trucks information in DS, and delete driver and trucks information in DS. The manage accounting 244 may include actions such as view orders related info for each DS, view payment items with statuses for each DS, generate invoice (pdf) for chosen period to charge DS, setup initial fee for DS, setup monthly subscription fee for DS, setup monthly subscription fee for drivers, and view payment items (subscription) with statuses for each driver.

In some embodiments, the customer module 250 allows a customer to take actions for user authorization 252, manage profile info 254, manage order request 256, mange orders 258, and notifications 260. The user authorization 252 may include actions such as sign-in and forgot password. The manage profile information 254 may include actions such as managing a customer's profile information. The manage order request 256 may include actions such as create order request, see order status, view quote with pre-calculated price, accept quote, and reject quote. The mange orders 258 may include actions such as view order status, cancel order, accept delivery (upload signatures with phone), and view orders history. The notifications 260 may include actions such as receive notifications about request status changing and receive notifications about Order status changing.

In some embodiments, the driver module 270 allows a driver to take actions for user authorization 272, manage profile info 274, manage job request 276, mange confirmed orders 278, notifications 280 and payments 282. The user authorization 272 may include actions such as sign-in and forgot password. The manage profile information 274 may include actions such as mange own profile, GPS location, Truck information; and mange status—available to accept job or not. The manage job request 276 may include actions such as view job request, accept job request, decline job request, and send a message/comment. The mange confirmed orders 278 may include actions such as send a message/comment, signature area (order status may be updated), and view own job list (All/For month/Unpaid only). The notifications 280 may include actions such as new job request and order cancellation. The payments 282 may include actions such as view weekly total commission for jobs.

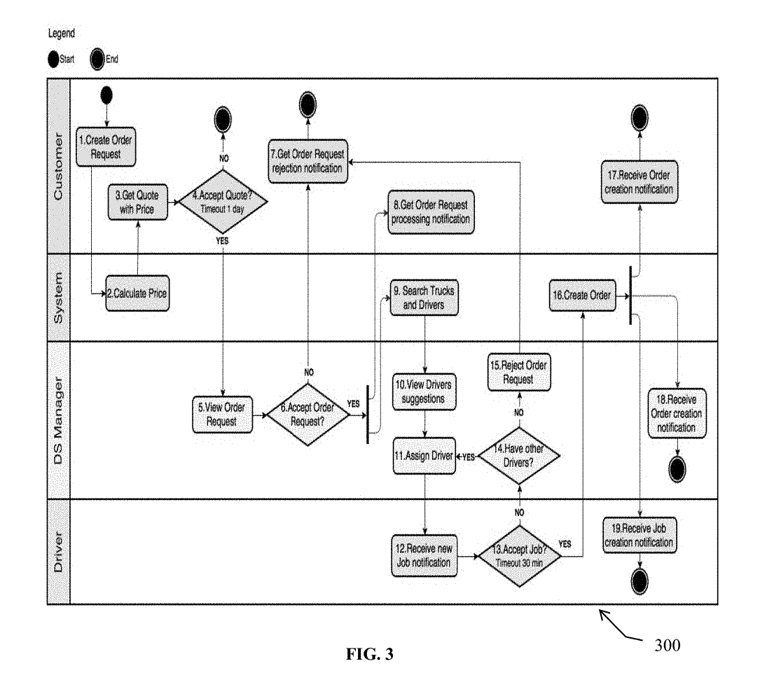

FIG. 3 illustrates a block diagram depicting an order request workflow according to various embodiments.

A method 300 can include can include creating an order request as operation 1. In operation 1, a customer 302 may create an order request from customer web portal or mobile app. The order request form may include the following exemplary fields: contact name, contact phone number, company name, company address (predefined), pick up address, delivery address, cargo information including number of pieces, weight of each piece and dimensions of each part, and additional info as free text format.

The method 300 can include calculating a quote price as operation 2. A system 304 may determine the quote price for shipping based on, for example:
base rate: price per mile*distance
weight of cargo, for example, (number of pieces*weight of each piece
size of cargo
driver fee
waiting time (for load, unload)
additional equipment needed
round trip distance (the distance may be determined by a service such as Google Maps)
price per mile, price per weight, price per size, additional charges that may be managed by a DS manager
permits needed, for example, a wide load permit.

The method 300 can include getting a quote with price as operation 3. The Customer 302 may receive a quote including a price, distance, time to expire and additional info. The distance may be determined by a service such as Google Maps.

The method 300 can include accepting a quote prior to expiration as operation 4. The customer 302 may accept a quote and continue to operation 4, or reject (not accept) a quote and the method 300 terminates. In some embodiments, a customer 302 may counter a quote price. In some embodiments, the time to expire may be set as 6 hours, 12 hours, 24 hours, 2 days or the like.

The method 300 can include viewing an order request as operation 5. A DS manager 306 may view the order request.

The method 300 can include accepting an order request as operation 6. The DS manager 306 may accept and continue to operations 8 and 9, or reject (not accept) the order request and continue to operation 7.

The method 300 can include getting an order rejection notification as operation 7. Operation 7 may be initiated by operation 6, operation 15 or the like. The customer 302 may get an order request rejection notification. The notification may provide a reason, for example, “the service is unavailable. Please call <<DS Manager>> at <<phone number>> for further information” or another reason as desired.

The method 300 can include getting an order processing notification as operation 8. Operation 7 may be initiated by operation 6 or the like. The customer 302 may get an order request processing notification. The notification may provide a status, for example, “<<DS Manager>> has begun processing your delivery request for <<Cargo>>.” or the like.

The method 300 can include searching trucks and drivers as operation 9. Operation 9 may be initiated by operation 6 or the like. The system 304 may generate a driver list by searching for available drivers and trucks capable of delivering the cargo. Each driver has own one or several trucks. The search includes: building a list of drivers available for a job that are presently active; and searching for applicable trucks through the active driver. In some embodiments, the active drivers may be drivers that running a Driver application associated with the driver. In some embodiments, the active drivers may be drivers that have called into dispatch. In some embodiments, the truck search may be based on a truck's carrying capacity or Gross Vehicle Weight (GVW), and length/dimensions.

The method 300 can include viewing driver suggestions as operation 10. Operation 10 may be initiated by operation 9 or the like. The DS Manager 306 may view the available drivers and trucks capable of delivering the cargo, i.e., with applicable trucks. In some embodiments, the driver list may be sorted by the truck's distance from the shipping location, for example, by showing the nearest drivers first.

The method 300 can include assigning drivers as operation 11. Operation 11 may be initiated by operation 10 or the like. The DS Manager 306 may select a driver and truck to fulfill the quote and create a new job request for the driver. In some embodiments, the DS Manager 306 may select the driver closest to the shipping location. In some embodiments, the DS Manager 306 may select the driver with relevant experience or can get to the shipping location in the least time, or the like.

The method 300 can include receiving a new job notification as operation 12. Operation 12 may be initiated by operation 11 or the like.

The method 300 can include accepting a job as operation 13. Operation 13 may be initiated after operation 12 or the like. A driver 308 reviews the incoming job request and has the ability to accept it or reject the job request. In some embodiments, there may an expiration timer associated with the job request. When the driver 308 responds prior to the expiration timer expiring, the response of the driver 308 is processed. When the driver 308 responds after expiration of the expiration timer, the response of the driver 308 is treated as a non-acceptance or rejection of the job request by the driver. The expiration timer may be set as 30 minutes, 1 hour, 2 hours, 4 hours or the like. In some embodiments, the driver 308 may provide additional info related to the job request in the acceptance. In some embodiments, the additional info may be free text.

The method 300 can include assigning other drivers as operation 14. Operation 14 may be initiated when the driver 308 rejects a job, for example, after operation 13 or the like. Operation 14 may review the driver list generated in operation 9 and determine whether the driver list includes drivers that have not rejected the job request. When the driver list includes drivers that have not rejected the job request, operation 11 for assigning drivers may be initiated. When the driver list not include drivers that have not rejected the job request, operation 15 for rejecting the quote/order may be initiated.

The method 300 can include assigning other drivers as operation 15. Operation 15 may be initiated when the driver list not include drivers that have not rejected the job request, for example, after operation 14 or the like. Operation 15 may mark the job request and order as rejected, and notify the customer 902 that initiated the order, for example, via operation 7.

The method 300 can include creating an order as operation 16. Operation 15 may be initiated when the driver 308 accepts the job request, for example, after operation 13 or the like. In some embodiments, when driver accepts the job the system 304 creates the order and notifies the customer 302 in operation 17, the DS manager 306 in operation 18, and the driver 308 in operation 19. In some embodiments, the driver 308 is marked as busy and the truck is marked as unavailable since they have assigned to the order. When a delivery is complete, the driver 308 notifies the system 304 or the DS manager 306, and the driver 308 and the truck are marked as available. In some embodiments, the system 306 may determine that deliver is complete when the customer 302 signs off on the delivery, for example, on the driver 308's smartphone, tablet or the like.

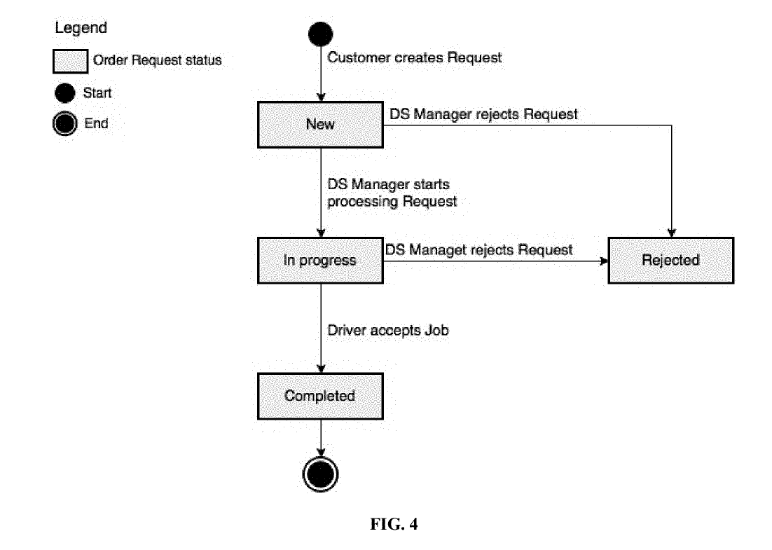

FIG. 4 illustrates a state-transition diagram for a customer request/quote status and its valid transitions according to various embodiments.

In exemplary embodiments, a delivery order may include a status parameter. A delivery order reflects parameters associated with an order or a quote. The status parameter may be set as New, In Progress, Rejected, Completed or the like. The delivery order status may be set or changed in response to actions taken by a customer, a DS manager, or a driver per operations included in method 300 of FIG. 3. For example, a New request may rejected or be placed In Progress by a DS Manager. Once a driver accepts an order, the order status may be set as Completed. A Completed request may have an associated order/job request that may be created upon the acceptance of the request by a driver.

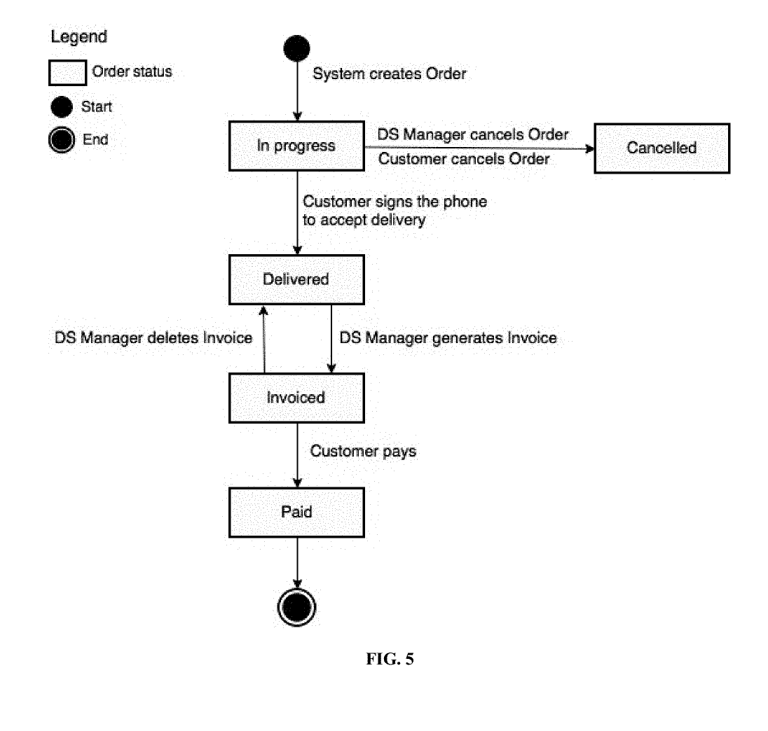

FIG. 5 illustrates a state-transition diagram for an order/job request status and its valid transitions according to various embodiments.

In exemplary embodiments, a job request may include a status parameter. An order/job request reflects parameters associated with an accepted order or quote. The status parameter may be set as In Progress, Cancelled, Delivered, Invoiced, Paid or the like. The order/job request status may be set or changed in response to actions taken by a customer, a DS manager, or a driver per operations included in method 300 of FIG. 3. Upon order/job request creation the status may be set to In Progress. If either the DS Manager or Customer cancels an order, the order's status may be set to Cancelled. When a customer accepts delivery at a destination, the order/job request may be set to Delivered. An invoice for the Delivered order/job request may be generated, and the associated status may be said to Invoiced. Upon payment of the invoice, the associated status may be set to Paid.

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents should only define the invention, rather than any specific examples given.

We claim as our invention:

1. A computer-implemented method for delivering cargo, the method comprising:
receiving a delivery request comprising a cargo description comprising an unconventional characteristic;
calculating a quote for the delivery request based on the unconventional characteristic;
selecting a driver and a linked truck to fulfill the delivery request;
creating a job order based on the delivery request for the driver and the linked truck; and
receiving a completion status for the job order.

2. The method of claim 1, wherein the unconventional characteristic comprises a cargo image and the calculating the quote is based on the cargo image.

3. The method of claim 1, wherein the unconventional characteristic comprises one or more of dimensions exceeding conventional road limits of weight, length or width, a cargo loading time estimate, a cargo unloading time estimate, a cargo handing equipment, a count of cargo handling personnel, or a permit.

4. The method of claim 1, wherein a driver is associated with one or more trucks, and the linked truck is selected from the one or more trucks based on the cargo description.

5. The method of claim 1, wherein the delivery request comprises a customer and the receiving the completion status further comprises invoicing the customer for the delivery request.

6. The method of claim 1, wherein the delivery request comprises an origination site and a delivery site, and the calculating comprises determining a distance between the origination site and the delivery site.

7. The method of claim 1, further comprising:
setting, by a delivery service manager, an acceptance or rejection of the delivery request; and
notifying a customer of the acceptance or rejection of the delivery request.

8. The method of claim 1, further comprising:
notifying a customer of the quote for the delivery request; and
receiving an acceptance or rejection of the quote from the customer.

9. The method of claim 1, further comprising:
notifying a driver of the job order, the linked truck and the unconventional characteristic; and
receiving an acceptance or rejection of the job order from the driver.

10. The method of claim 9, wherein when the driver rejects the delivery order, the method further comprises selecting a second driver different from the driver and notifying the second driver of the job order.

11. The method of claim 9, wherein the notifying comprises communicating with a mobile device assigned to the driver.

12. The method of claim 1, wherein the job order comprises a delivery site and the completion status comprises a consignee's signature at the delivery site.

13. The method of claim 1, wherein the job order comprises an origination site and the completion status comprises an image of the cargo at the origination site.

14. The method of claim 1, wherein the job order comprises a delivery site and the completion status comprises an image of the cargo at the delivery site.

15. The method of claim 1, wherein the job order comprises an origination site and the selecting comprises selecting the driver closest to the origination site.

16. A computer-implemented method for delivering cargo, the method comprising:
receiving a delivery request comprising a cargo description, an origination site and a delivery site;
calculating a quote for the delivery;
setting, by a delivery service manager, an acceptance or rejection of the delivery request;
notifying a customer of the acceptance or rejection of the delivery request and the quote;
receiving an acceptance or rejection of the quote from the customer;
selecting a driver and a linked truck to fulfill the delivery request;
creating a job order based on the delivery request for the driver and the linked truck; and
receiving a completion status for the job order.

17. The method of claim 16, wherein the cargo description comprises a cargo image and the calculating the quote is based on the cargo image.

18. The method of claim 16, wherein the job order comprises a delivery site and the completion status comprises an image of the cargo at the delivery site.

19. The method of claim 16, further comprising:
notifying a driver of the job order and the linked truck; and
receiving an acceptance or rejection of the job order from the driver.

20. The method of claim 19, wherein when the driver rejects the delivery order, the method further comprises selecting a second driver different from the driver and notifying the second driver of the job order.
